(19) United States
(12) Patent Application Publication
(10) Pub. No.: US 2006/0245301 A1
(43) Pub. Date: Nov. 2, 2006

(54) Electronic sensor which can be communicated with

(76) Inventor: Frank Charles Wroga, Woodstock, IL (US)

Correspondence Address: FRANK C. WROGA, 935 DIECKMAN, WOODSTOCK, IL, 60098, US

(21) Appl. No.: 11/116,154

(22) Filed: Apr. 28, 2005

(51) Int. Cl. H04B 1/06

(52) U.S. Cl. 367/135; 367/903

(57) ABSTRACT

An electronic sensor, such as, for example, an ultrasonic ranging sensor, that can be communicated with by touching the sensor's transducer or touching the transducer output wire to the input wire for specific, preprogrammed time periods. The electronics recognizes the touch, times its duration, and responds in a preprogrammed manner. This allows the user to input information to the sensor without the use of additional components such as pushbuttons, keypads, switches, potentiometers and the like.

### CROSS REFERENCE TO RELATED APPLICATIONS

None

### STATEMENT REGARDING FED SPONSORED R & D

No federal funds were used in the development of this invention REFERENCE TO SEQUENCE LISTING, A TABLE OR COMPUTER PROGRAM LISTING APPENDIX

None

### BACKGROUND OF THE INVENTION

1. Field of the Invention

The present invention relates to a unique method for a user to communicate information with the electronics of a sensor such as an ultrasonic ranging sensor, a load sensor, a pressure sensor, optical sensors, and the like.

2. Description of Prior Art

Most sensors consist of a transducer that interacts with the environment and electronics to power the transducer and to sense the transducer output. For example, an ultrasonic ranging transducer as described in U.S. Pat. Nos. 6,202,034; 5,793,704; and 5,568,449 consists basically of a piezo electric transducer and electronics to provide power to the transducer and sense the output signal from the transducer. Conventionally, information, such as setup information, is communicated to the electronics of a sensor, which might include a controller or microprocessor, by means of push buttons, key pads, potentiometers, switches and the like. These components add complexity and cost to the sensor, and can adversely impact the reliability of the sensor. The present invention eliminates the need for additional components to communicate with the electronics of a sensor.

### SUMMARY OF THE INVENTION

The present invention is a means of communicating with the electronics of a sensor by touching the transducer for a specified period of time. Touching the transducer can radically alter the output signal of the transducer, which when recognized by the electronics alerts the sensor that the user wishes to communicate with it. The sensor electronics can be preprogrammed to recognize the length of time of the contact, and it can react differently for different length of times of contact with the transducer. Alternately, the user can touch the power input wire to the output wire, which will dramatically alter the output signal, for a specified period of time to alert the sensor electronics that communications is desired. Alternately, a control wire can be touched to the power input wire for a specified period of time.

For example, the operating range of an ultrasonic ranging sensor can be setup in the following way using the current invention. The piezo electric transducer is touched, or the output or control wire is touched to the input wire, for say five seconds. The electronics senses that the transducer is being touched since the ultrasonic output signal is greatly altered. The electronics then times the length of the contact. After the five seconds the electronics can flash a green light emitting diode (LED) to alert the user that the sensor is ready to set the maximum range. The user then removes his finger from the transducer. The electronics is preprogrammed to respond to a five-second contact by accepting an output signal from an object placed at the sensor's maximum range. When the sensor has recognized the maximum range the green LED stops flashing. The sensor is now programmed to accept to detect any object at any distance up to the maximum range.

The transducer then can be touched for a different time period say ten seconds. The preprogrammed electronics responds to the ten-second contact by flashing a red LED and, after the touch is removed, accepting an output signal from an object placed at the sensor's minimum range. The sensor is now programmed to detect an object at any distance between the minimum and maximum range.

Alternately, the preceding two programming steps can be initiated by touching the output wire or control wire to the input power wire instead of touching the transducer.

In this way the sensor is taught what its maximum and minimum range is, and it is accomplished without any type of additional imputing components. The sensor transducer itself or the input, output and control wires are employed to communicate with the sensor.

A single bicolor (red and green) LED can be used to replace the two LEDs discussed above. A third color (amber) can be obtained for another purpose by lighting both parts of the bicolor LED.

Other types of sensors having transducers such as load cells, pressure monitors and the like can be communicated with in a similar way, namely by touching the transducer or by connecting the output wire or control wire to the input wire for a preprogrammed period of time.

### BRIEF DESCRIPTION OF THE DRAWINGS

These and other objects and advantages of the present invention will become apparent by reference to the following description and accompanying drawings wherein:

FIG. 1 is a schematic block diagram of a generic sensor incorporating the present invention.

FIG. 2 is a schematic block diagram of an ultrasonic ranging sensor incorporating the present invention.

### DESCRIPTION OF THE PREFERRED EMBODIMENTS

Referring now to the drawings, description will be given of the embodiments of a generic sensor and, for an example, an ultrasonic ranging sensor incorporating the present invention.

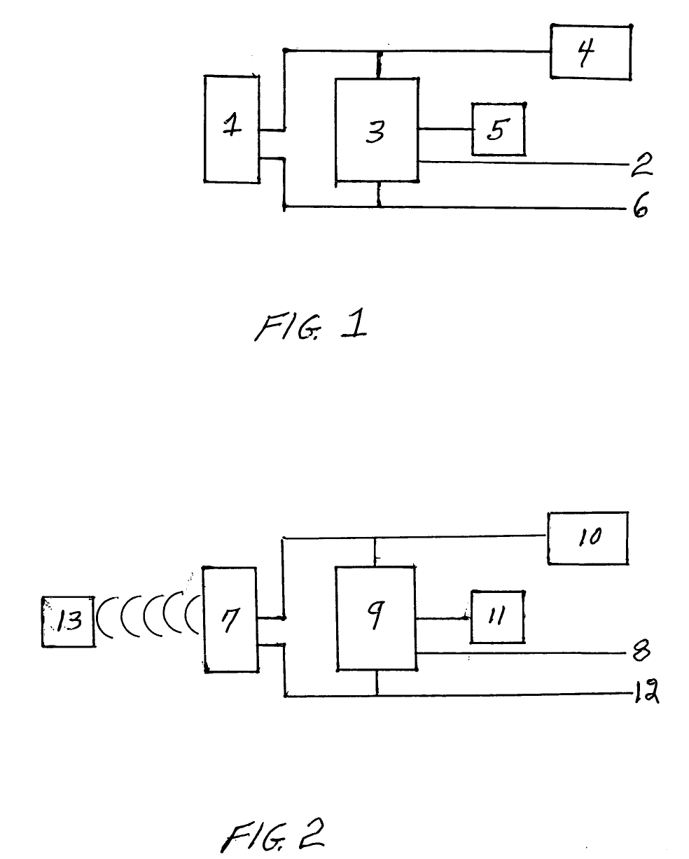

FIG. 1 is a block diagram of a generic sensor incorporating the present invention. The sensor consists of a transducer 1, electronics including a controller or microprocessor 3, a power supply (input) 4, a timer 5, control wire 2, and transducer output wire 6. The power supply 4 supplies power to the transducer 1 and the remaining electronics. The output wire 6 carries the output signal from the transducer 1. When it is desired by the user to communicate with the sensor, the transducer 1 is touched for a specified period of time or the output wire 6 or control wire 2 is touched to the input 4. The electronics senses that the transducer 1 or input and control or output wires are being touched since the output signal is greatly altered by the touch. When this occurs, the timer 5 is started to determine the length of time the transducer 1 or the input/output wires are being touched. When the touch is removed, the output signal returns to a more normal value and the timer 5 is turned off The controller or microprocessor 3, which is preprogrammed with instructions, looks at the time interval that the transducer or wires were touched and selects the preprogrammed instructions. The user can then communicate with the sensor in the preprogrammed manner. After a time period for communication the sensor reverts back to normal operation. Light emitting diodes can be flashed to prompt the user that the different time intervals have elapsed.

As an example, FIG. 2 is a block diagram of an ultrasonic ranging transducer. The transducer 7 is a piezo electric crystal that can be electrically excited by the power supply 10 to emit a pulse of high frequency sound. This ultrasound wave is reflected by an object 13 in the sound waves path and returns to the transducer where an electrical signal is generated and is directed to the output line 12. The time period between when the sound pulse leaves the transducer 7, is reflected by the object 13 and returns to the transducer 7 is a measure of the distance from the transducer 7 to the object 13 (the object's range).

The user for example may wish to “teach” the sensor values of maximum and minimum range that it should respond to. This can be done employing the present invention. The user touches the transducer 7 or touches the output wire 12 or control wire 8 to the input wire 10 for a specific time period, say 5 seconds. The output signal dramatically changes because of this. The change is sensed by the electronics and the timer 11 measures the duration of the touch. A green LED can be flashed when the five seconds has elapsed. The preprogrammed controller or microprocessor 9 knows that a five-second touch means that the user desires to set the maximum range for the sensor. The user has placed an object 13 in the path of the ultrasound wave at the desired maximum distance. The sensor thus “learns” the maximum range. After a preset period of time for communication the sensor reverts back to normal operation.

The minimum range can be “taught” to the sensor by touching the transducer 1 or the output wire 12 or control wire 8 to the input wire 10 for say ten seconds. Now a red LED can be flashed. The preprogrammed controller or microprocessor 9 knows that this means that the user wishes to set the minimum range. The user has placed an object in the sound waves path at the desired minimum range and thus the sensor “learns” the minimum range.

In this way the user has communicated with the sensor without requiring any additional components such as switches, buttons, keypads, potentiometers, and the like. This lowers the cost of the sensor, reduces its complexity and increases its reliability.

While the particular embodiments of the invention have been shown and described, it will be obvious to those skilled in the art that various changes and modifications may be made without departing from the present invention in its broadest aspects.

We claim:

1. A sensor that can be communicated with for the purpose of programming the sensor by touching the transducer or touching the output wire or control wire to the input wire for specific periods of time.

2. A sensor as claimed in claim 1 that incorporates a controller or microprocessor with preprogrammed instructions for communication, a timer, and LEDs for user feedback.

3. An ultrasonic ranging sensor that can be communicated with by touching the transducer or touching the output wire or control wire to the input wire for specific periods of time.

4. An ultrasonic ranging sensor as claimed in claim 3 that incorporates a controller or microprocessor with preprogrammed instructions for communication, a timer and LEDs for user feedback.
